(19) United States
(12) Patent Application Publication
(10) Pub. No.: US 2011/0211714 A1
(43) Pub. Date: Sep. 1, 2011

(54) ANTENNA UNIT AND WIRELESS TRANSMISSION AND/OR RECEIVING UNIT

(76) Inventor: Frank Plath, Wedemark (DE)

(21) Appl. No.: 13/061,285

(22) PCT Filed: Sep. 1, 2009
(86) PCT No.: PCT/EP09/61275

§ 371 Date: May 11, 2011

(30) Foreign Application Priority Data
Sep. 1, 2008 (DE) 102008045111.8

(51) Int. Cl. H04R 3/00; H01Q 1/00

(52) U.S. Cl. 381/122; 343/904

(57) ABSTRACT

There is provided an antenna unit comprising an antenna element and at least one high-dielectric supplemental element disposed in the proximity of the antenna element.

The present application claims priority from PCT Patent Application No. PCT/EP2009/061275 filed on Sep. 1, 2009, which claims priority from German Patent Application No. DE 10 2008 145 111.8 filed on Sep. 1, 2008, the disclosures of which are incorporated herein by reference in their entirety.

### BACKGROUND OF THE INVENTION

1. Field of the Invention

The present invention concerns an antenna unit and a wireless transmitting and/or receiving unit.

In the case of wireless transmitting and/or receiving units having an antenna for wireless transmission and reception, it can happen, in an area of use close to a body, that the resonance frequency of the antenna is in part severely detuned by the proximity to the body or by a change in the relationship between the antenna and a body. That for example can cause a transmission loss effect so that antenna performance is reduced. That problem occurs to an increased degree in devices which only have a small amount of space available to them.

2. Description of Related Art

In known antenna units, there is typically provided a large-area antenna configuration to reduce detuning of the resonance frequency of the antenna. With the antenna being of such a large-area nature however it can happen that, because of its large diameter, the antenna can no longer be immediately distinguished from the housing of a wireless transmitting and/or receiving unit (for example a microphone handle). The result of that can be that it is not the housing but the antenna that is grasped and is thus damped.

### SUMMARY OF THE INVENTION

Therefore an object of the present invention is to provide an antenna unit and a wireless transmitting and/or receiving unit which are less sensitive in respect of detuning of the resonance frequency.

That object is attained by an antenna unit as set forth in claim 1 and by a wireless transmitting and/or receiving unit as set forth in claim 4.

Thus there is provided an antenna unit comprising an antenna element and at least one high-dielectric supplemental element disposed in the proximity of the antenna element.

In a further aspect of the present invention the high-dielectric supplemental element has a dielectric constant of 0-100.

In a further aspect of the present invention the spacing between the antenna element and the high-dielectric supplemental element is 0-5 mm, preferably 0-3 mm.

The invention also concerns a wireless transmitting and/or receiving unit having an above-described antenna unit. The wireless transmitting and/or receiving unit can be for example in the form of a wireless microphone.

The invention concerns the concept of placing high-dielectric low-lossy materials in the proximity of the antenna. Thus there is provided an antenna which is detuned from the outset by the high-dielectric material in the proximity of the antenna. The closer the dielectric material is arranged to the antenna, the corresponding better is the action involved.

The invention is based on the realisation that antennas of microphone transmitters and/or receivers are usually of a shortened structure as the dimensions of the microphone transmitters and/or receivers are limited. The shortening of the antenna can be effected by a wound-up or meandered metallic structure. Alternatively or additionally thereto it is possible to provide a large roof capacitance. Alternatively it is possible to permit a dielectric shortening of the antenna geometry. That however does not represent a preferred solution because the wireless microphones are typically to be operated in a wide frequency range and a large number of different antennas have been developed.

In this respect however it is to be pointed out that the antenna-specific resonance frequency is detuned if additional materials (such as for example a hand, a body, damp clothing, a chair or an armchair) are moved towards the antenna unit. That leads to a further electromagnetic damping effect. The result of that in turn is that the reflected HF power is increased at the antenna base point.

Further configurations of the invention are subject-matter of the appendant claims.

### BRIEF DESCRIPTION OF THE DRAWINGS

FIG. 1 shows a diagrammatic view of a wireless microphone having an antenna unit according to the invention.

### DETAILED DESCRIPTION OF EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments.

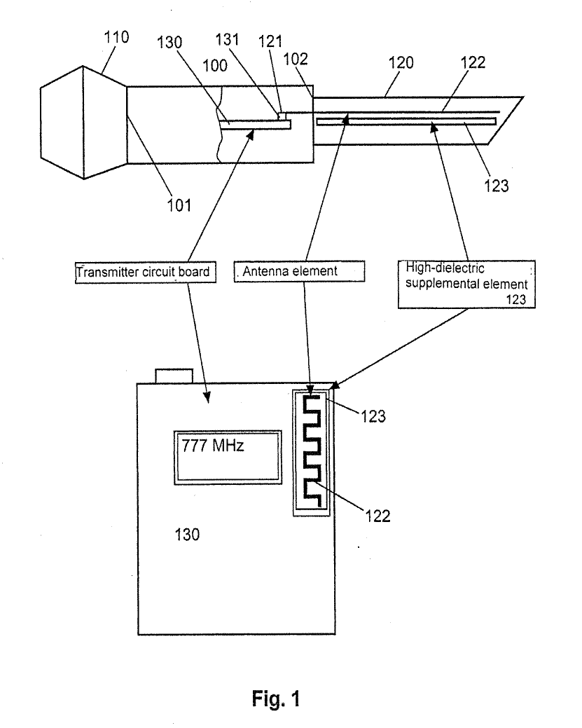

FIG. 1 shows a diagrammatic view of a wireless microphone having an antenna unit according to the invention. The wireless microphone 100 has a microphone head 110 at its first end 101 and an antenna unit 120 at the second end 102. Provided within the wireless microphone is a transmitter circuit board 130 which is coupled by way of an end 131 to an end 121 of the antenna unit 120. Besides the antenna element 122 the antenna unit 120 has one or more (high-) dielectric supplemental elements 123.

The arrangement of the high-dielectric supplemental elements 123 in the proximity of the antenna element 122 provides that the supplemental element 123 has an influence on the resonance frequency of the antenna. That influence is improved, the closer the supplemental element is arranged to the antenna unit. If now for example human tissue with a relative dielectric constant of about 80 is in the proximity of the antenna unit 120, the human tissue would then have a markedly lesser influence on the resonance frequency of the antenna unit 120, than due to the additional element 123.

The antenna element 122 can be for example in the form of a structure on a polyimide film, on a circuit board material FR4 or it can be in the form of a coil. In that case the antenna is electrically extended by a direct proximity of a dielectric which is independent of the antenna.

To achieve different frequency ranges, it is only necessary to use a dielectric supplemental element, apart from different circuit boards for the antenna elements.

If moreover the optical implementation of a protective spacing between the antenna and the housing is optimised, then the frequency shift of the antenna can be reduced. That can lead in particular to lower field strength fade effects when the antenna unit is touched.

The mechanical shortening of the antenna can thus be effected by means of the additional high-dielectric supplemental element 123. Additionally or alternatively thereto it is possible to provide for a further meandering or wound-up configuration for the metallic structure.

The high-dielectric element 120 can have a dielectric coefficient of 0-100.

The spacing between the antenna element 122 and the supplemental element 123 can be between 0-5 mm or between 0-3 mm.

The above-described antenna unit can be used or implemented in a wireless microphone, a wireless hand transmitter, a wireless pocket transmitter or in a wireless camera transmitter.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claims.

1. An antenna unit comprising;
an antenna element; and
at least one high-dielectric supplemental element, which is disposed in the proximity of, and parallel to the antenna element, and extends along the length of the antenna element.

2. The antenna unit as set forth in claim 1;
wherein the high-dielectric supplemental element has a dielectric constant of 0 to 100.

3. The antenna unit as set forth in claim 1;
wherein the spacing between the antenna element and the high-dielectric supplemental element 0 to 5 mm.

4. A wireless transmitting and/or receiving unit comprising:
an antenna unit as set forth in one of claims 1 through 3.

5. A wireless microphone comprising:
an antenna unit as set forth in one of claims 1 through 3.

6. The antenna unit as set forth in claim 2;
wherein the spacing between the antenna element and the high-dielectric supplemental element is 0 to 5 mm, preferably 0 to 3 mm.
